(19) United States
(12) Patent Application Publication
(10) Pub. No.: US 2024/0276030 A1
(43) Pub. Date: Aug. 15, 2024

(54) DISPLAY METHOD, DATA PROCESSING METHOD, APPARATUS, ELECTRONIC DEVICE AND COMPUTER MEDIUM

(71) Applicant: Beijing Zitiao Network Technology Co., Ltd., Beijing (CN)

(72) Inventors: Fanchao MENG, Beijing (CN); Zhenpeng Xiao, Beijing (CN); Ruixi Chang, Beijing (CN); Qiang Chen, Beijing (CN); Tuoyu Qi, Beijing (CN); Liyue Ji, Bejing (CN); Yang Wu, Beijing (CN); Ren Zhou, Beijing (CN); Zuohui Tian, Beijing (CN); Kai Cui, Beijing (CN)

(21) Appl. No.: 18/439,984

(22) Filed: Feb. 13, 2024

(30) Foreign Application Priority Data
Feb. 13, 2023 (CN) 202310140524.X

(51) Int. Cl. H04N 21/2187; G06F 3/01; G06F 3/0486; H04N 21/431; H04N 21/4788

(52) U.S. Cl. CPC H04N 21/2187; G06F 3/012; G06F 3/0486; H04N 21/4312; H04N 21/4788

(57) ABSTRACT

The present application discloses a display method and apparatus, a data processing method and apparatus, an electronic device and a computer medium. The display method comprises: displaying a first live streaming scene in a set playing field space; and in response to a preset operation, presenting a first display screen at a first location in the playing field space and displaying a second live streaming scene in the first display screen. Therefore, the flexibility of a display mode of a live streaming room can be improved, and the user experience is improved.

### CROSS-REFERENCE TO RELATED APPLICATION(S)

This application claims priority to Chinese Application No. 202310140524.X filed on Feb. 13, 2023, the disclosure of which is incorporated herein by reference in its entities.

### FIELD

The present application belongs to the technical field of network live streaming, and in particular to a display method, a data processing method, apparatuses, an electronic device and a computer medium.

### BACKGROUND

With the rapid development of Internet and streaming media technologies, various live streaming application programs emerge in endlessly, and viewing network live streaming becomes a daily entertainment mode of a lot of users. In related arts, picture display of a network live streaming room may only be displayed in a two-dimensional mode, such that the display mode of the live streaming room is relatively humdrum, and thus the user experience is worse.

### SUMMARY

Embodiments of the present application provide an implementation solution different from related arts, so as to solve the technical problem in the related arts that picture display of a network live streaming room may only be displayed in a two-dimensional mode, such that the display mode of the live streaming room is relatively single, and thus the user experience is worse.

In a first aspect, the present application provides a display method, including:
displaying a first live streaming scene in a set playing field space; and
in response to a preset operation, presenting a first display screen at a first location in the playing field space and displaying a second live streaming scene in the first display screen.

In a second aspect, the present application provides a data processing method, including:
acquiring picture information, wherein the picture information comprises: a first live streaming scene corresponding to a first device, a first location, first information used for instructing a head-mounted display device to display a first display screen, and a second live streaming scene to be displayed in the first display screen; and
sending the picture information to the head-mounted display device to cause the head-mounted display device to display the first live streaming scene in a set playing field space, and in response to a preset operation, presenting the first display screen at the first location in the playing field space and displaying the second live streaming scene in the first display screen.

In a third aspect, the present application provides a display apparatus, including:
a first display unit, configured to display a first live streaming scene in a set playing field space; and
a second display unit, configured to in response to a preset operation, present a first display screen at a first location in the playing field space and display a second live streaming scene in the first display screen.

In a fourth aspect, the present application provides a data processing apparatus, including:
an acquisition unit, used for acquiring picture information, wherein the picture information comprises: a first live streaming scene corresponding to a first device, a first location, first information used for instructing a head-mounted display device to display a first display screen, and a second live streaming scene to be displayed in the first display screen; and
a sending unit, configured to send the picture information to the head-mounted display device to cause the head-mounted display device to display the first live streaming scene in a set playing field space, and in response to a preset operation, present the first display screen at the first location in the playing field space and display the second live streaming scene in the first display screen.

In a fifth aspect, the present application provides an electronic device, including:
a processor; and
a memory, used for storing an executable instruction of the processor,
wherein the processor is configured to execute any method in the first aspect, the second aspect, various possible implementations of the first aspect, or various possible implementations of the second aspect by executing the executable instruction.

In a sixth aspect, an embodiment of the present application provides a computer-readable storage medium, on which a computer program is stored, wherein the computer program, when executed by a processor, implements any method in the first aspect, the second aspect, various possible implementations of the first aspect, or various possible implementations of the second aspect.

By means of the solution provided in the present application in which the first live streaming scene is displayed in the set playing field space, the first display screen is displayed at the first location in the playing field space in response to the preset operation, and the second live streaming scene is displayed in the first display screen, the first live streaming scene can be displayed in a three-dimensional playing field space, thereby improving the flexibility of a display mode of a live streaming room, and improving the user experience.

### BRIEF DESCRIPTION OF THE DRAWINGS

To illustrate technical solutions in the embodiments of the present application or in related arts more clearly, a brief introduction on the drawings which are needed in the description of the embodiments or the related arts is given below. Apparently, the drawings in the description below are merely some of the embodiments of the present application, based on which other drawings may be obtained by those ordinary skilled in the art without any creative effort.

FIG. 1 is a schematic structural diagram of a system provided in an exemplary embodiment of the present application;

FIG. 2 is a schematic flowchart of a display method provided in an exemplary embodiment of the present application;

FIG. 3 is a schematic top view of a playing field space provided in an embodiment of the present application;

FIG. 4 is a schematic top view of a playing field space provided in an embodiment of the present application;

FIG. 5 is a schematic diagram of a second display screen provided in an embodiment of the present application;

FIG. 6 is a front view of a playing field space provided in an embodiment of the present application;

FIG. 7 is a schematic diagram of a fourth display screen provided in an embodiment of the present application;

FIG. 8 is a schematic diagram of ranking information provided in an embodiment of the present application;

FIG. 9 is a schematic diagram of a display process of displaying a fourth display screen above a first display screen according to a first preset display mode provided in an embodiment of the present application, when the first preset display mode is a splitting effect;

FIG. 10 is a schematic diagram of a process of displaying a first display screen at a first location in a playing field space according to a second preset display mode provided in an embodiment of the present application, when the second preset display mode is a wipe effect;

FIG. 11 is a schematic flowchart of a data processing method provided in an exemplary embodiment of the present application;

FIG. 12 is a schematic structural diagram of a display apparatus provided in an exemplary embodiment of the present application;

FIG. 13 is a schematic structural diagram of a data processing apparatus 130 provided in an exemplary embodiment of the present application; and

FIG. 14 is a schematic structural diagram of an electronic device provided in an embodiment of the present application.

### DETAILED DESCRIPTION OF EMBODIMENTS

Embodiments of the present application are described in detail below, and examples of the embodiments are shown in the drawings. The embodiments described below with reference to the drawings are exemplary, and are intended to explain the present application, but cannot be construed as limiting the present application.

The terms “first” and “second” and the like in the specification, the claims and the drawings of the embodiments of the present application are used for distinguishing similar objects, and are not necessarily used for describing a specific sequence or precedence order. It should be understood that the data used in this way may be interchanged under appropriate circumstances, so that the embodiments of the present application described herein may be implemented in a sequence other than those illustrated or described herein. In addition, the terms “including” and “having”, and any variations thereof are intended to cover non-exclusive inclusions, for example, processes, methods, systems, products or devices including a series of steps or units are not necessarily limited to those clearly listed steps or units, but may include other steps or units that are not clearly listed or are inherent to these processes, methods, products or devices.

First, some terms in the embodiments of the present application are explained below, so as to facilitate the understanding of those skilled in the art.

An AR technology is a technology for skillfully fusing virtual information with a real world, which widely uses various technical means such as multimedia, three-dimensional modeling, real-time tracking and registration, intelligent interaction and sensing, simulates virtual information generated by a computer, such as words, images, three-dimensional models, music and videos, and then applies the virtual information to the real world. The two kinds of information are complementary to each other, thereby implementing “enhancement” of the real world.

A VR technology is also referred to as a virtual reality or spiritual realm technology, the basic implementation of which is to utilize, mainly relying on a computer technology, the latest development results of a variety of high technologies to generate, by means of a computer and other devices, a vivid virtual world of various sensory experiences such as three-dimensional vision, tactile sense and smell, so that a person in the virtual world generates an immersive feeling.

MR is a further development of the virtual reality technology. In the technology, virtual scene information is presented in a real scene, and an interaction and feedback information loop is built among the real world, the virtual world and the user, so as to enhance the sense of reality of user experience.

A global positioning system (GPS) is a high-precision radio navigation positioning system based on an artificial earth satellite, which may provide accurate geographical locations, vehicle speeds and accurate time information at any place in the world and in a terrestrial space.

2D: 2-dimension in full name, that is, two-dimension, and content on one plane is two-dimensional. The two-dimension refers to a left-right direction and a front-rear direction, and there is no upper-lower direction.

3D: 3-dimension in full name, that is, three-dimension, which refers to a space system formed by adding a direction vector into a planar two-dimensional system. The three-dimension is three axes of a coordinate axis, that is, an x-axis, a y-axis, and a x-axis, where x represents a left-right space, y represents a front-rear space, and z represents an upper-lower space.

A 3D camera, which has dozens of functions such as facial recognition, gesture recognition, human skeleton recognition, three-dimensional measurement, environmental perception, three-dimensional map reconstruction, and so on, and may be widely applied to the fields of televisions, mobile phones, robots, unmanned aerial vehicles, logistics, VR/AR, smart home, security and protection, automobile driving assistance, etc.

With the rapid development of Internet and streaming media technologies, various live streaming application programs emerge in endlessly, and viewing network live streaming becomes a daily entertainment mode of a plurality of users. In related arts, picture display of a network live streaming room may only be displayed in a two-dimensional mode, such that the display mode of a live streaming room is relatively single, and thus the user experience is worse. In order to solve the technical problem, the present application provides a display method and apparatus, a data processing method and apparatus, an electronic device and a computer medium, so as to solve the technical problem in the related arts that picture display of a network live streaming room may only be displayed in the two-dimensional mode, such that the display mode of the live streaming room is relatively single, and thus the user experience is worse.

The technical solutions of the present application and how the technical solutions of the present application solve the above technical problem will be described in detail below with specific embodiments. The following several specific embodiments may be combined with each other, and the same or similar concepts or processes may not be repeated in some embodiments. The embodiments of the present application will be described below in combination with the drawings.

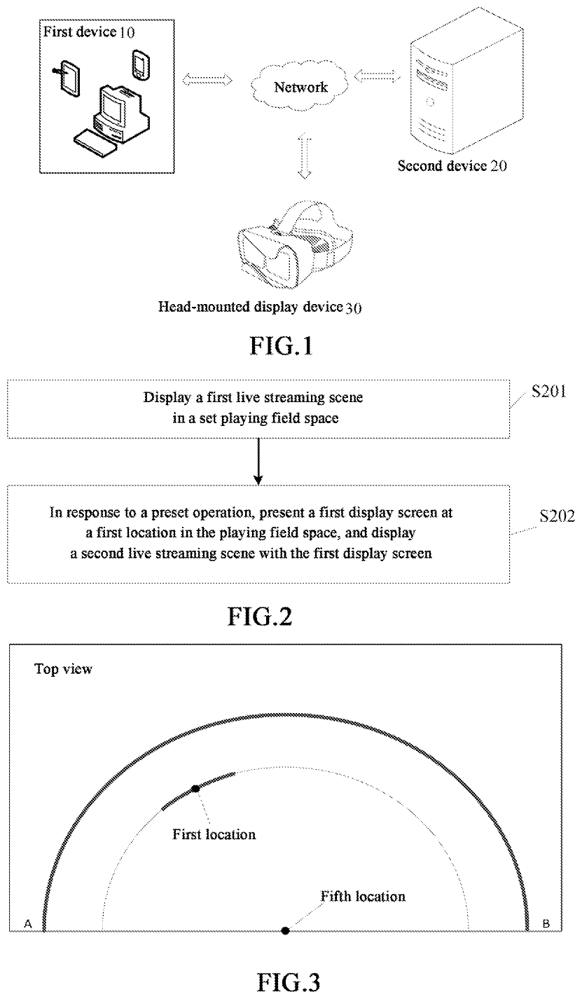

FIG. 1 is a schematic structural diagram of a system provided in an exemplary embodiment of the present application. The structure comprises: a first device 10, a second device 20 and a head-mounted display device 30. The first device 10, the second device 20 and the head-mounted display device 30 are connected through a network, for example, through a wired or wireless network, etc.

The first device 10 may be a terminal device such as a smart phone, a tablet computer, a computer, and the like; and the second device 20 may be a server, the server may be an independent physical server, or may be a server cluster or a distributed system composed of a plurality of physical servers, or may be a cloud server that provides basic cloud computing services such as cloud services, cloud databases, cloud computing, cloud functions, cloud storage, network services, cloud communication, middleware services, domain name services, security services, a content delivery network (CDN), big data and artificial intelligence platforms, etc.

The first device 10 may be connected with an input device such as a camera and a microphone, and is used for collecting live streaming data and sending the live streaming data to the second device 20, wherein the camera may be a 3D camera.

In some embodiments, the second device 20 is used for executing the following data processing method: acquiring picture information, wherein the picture information comprises: a first live streaming scene corresponding to the first device, a first location, first information used for instructing the head-mounted display device to display a first display screen, and a second live streaming scene to be displayed in the first display screen; and sending the picture information to the head-mounted display device to cause the head-mounted display device to display the first live streaming scene in a set playing field space, in response to a preset operation, presenting the first display screen at the first location in the playing field space and displaying the second live streaming scene in the first display screen.

The current first live streaming scene is obtained on the basis of live streaming data sent by the first device.

In some embodiments, the head-mounted display device 30 may be used for executing the following display method: displaying a first live streaming scene in a set playing field space; and in response to a preset operation, presenting a first display screen at a first location in the playing field space and displaying a second live streaming scene in the first display screen.

Optionally, the head-mounted display device 30 may be provided with a displayer, and the playing field space displayed by the displayer may be a three-dimensional picture.

In some embodiments, the playing field space may be a virtual reality scene space, a mixed reality scene space, or an augmented reality scene space, etc.

In some embodiments, the first live streaming scene is a live streaming room picture of the first device.

The detailed implementation of the display method and the specific functions of the head-mounted display device 30 or the second device 20 mentioned above are respectively described in detail below. It should be noted that the following description sequence of the embodiments is not used as a limitation on the priority sequence of the embodiments.

FIG. 2 is a schematic flowchart of a display method provided in an exemplary embodiment of the present application, the method may be applied to the head-mounted display device 30, and the method at least includes the following steps S201 to S202:

S201, displaying a first live streaming scene in a set playing field space.

In some embodiments, the set playing field space is a 3D space.

In some embodiments, the set playing field space is a 180° spherical space or a 360° spherical space.

In some embodiments, the head-mounted display device is provided with a displayer, and the set playing field space may be displayed in the displayer.

In some embodiments, the first live streaming scene is a 180° 3D video stream picture, and the second live streaming scene is a 2D video stream picture.

In some embodiments, the 3D video stream picture may be a picture of a virtual reality scene, a picture of a mixed reality scene, or a picture of an augmented reality scene, etc.

In some embodiments, the first live streaming scene may be a video stream picture of a live streaming room which a user wearing the head-mounted display device selects for viewing.

In some embodiments, in the set playing field space, the current first live streaming scene may be displayed in a curved-surface picture, or may be displayed in a planar picture.

In some embodiments, when the first live streaming scene is displayed in the curved-surface picture, referring to FIG. 3, FIG. 3 is a schematic top view of the playing field space provided in an embodiment of the present application, and a curved surface shown by an arc AB in FIG. 3 may be used for displaying the first live streaming scene.

S202, in response to a preset operation, presenting a first display screen at a first location in the playing field space and displaying a second live streaming scene in the first display screen.

In some embodiments, the distance between the first location and a virtual object corresponding to the user is less than the distance between the first live streaming scene and the virtual object.

In some embodiments, the second live streaming scene may be a live streaming room scene, which currently interacts with the first live streaming scene (such as microphone connection and competition).

In some embodiments, the first display screen may be a curved-surface screen or a planar screen.

In some embodiments, the second live streaming scene is a 2D video stream picture; and
in some other embodiments, the second live streaming scene may also be a 3D video stream picture.

In some embodiments, the virtual object corresponding to the user is included in the set playing field space. Referring to FIG. 3, a fifth location may be a location where the virtual object is located, the fifth location may correspond to one coordinate, and the coordinate may be a three-dimensional coordinate.

In some embodiments, the first location may be preset, and the first location may be a three-dimensional coordinate. In some embodiments, the distance between the first location and the virtual object corresponding to the user is the distance between the first location and the fifth location.

In some embodiments, in the present application, when the first display screen, a second display screen, a third display screen and a fourth display screen are displayed at a same location, it refers to that the center of the corresponding screen or the center of the bottom of the screen coincides with the location. The location may refer to any one of the first location, a second location, a third location and a fourth location.

According to the scheme provided in the present application, by means of displaying the first live streaming scene in the set playing field space, and in response to the preset operation, presenting the first display screen at the first location in the playing field space and displaying the second live streaming scene in the first display screen, the first live streaming scene can be displayed in a three-dimensional playing field space, thereby improving the flexibility of a display mode of a live streaming room, and improving the user experience.

In some embodiments, the method further comprises:
displaying a second display screen at a second location in the playing field space, wherein the second display screen is used for displaying at least one of: a live streaming list of a live streaming platform in a live streaming state, live streamer information corresponding to the first live streaming scene, online audience information corresponding to the first live streaming scene, a definition setting option corresponding to the first live streaming scene, a dimension setting option corresponding to the first live streaming scene, and a setting option of whether to display bullet-screen messages of the competition, wherein the distance between the second location and the virtual object is less than the distance between the first location and the virtual object.

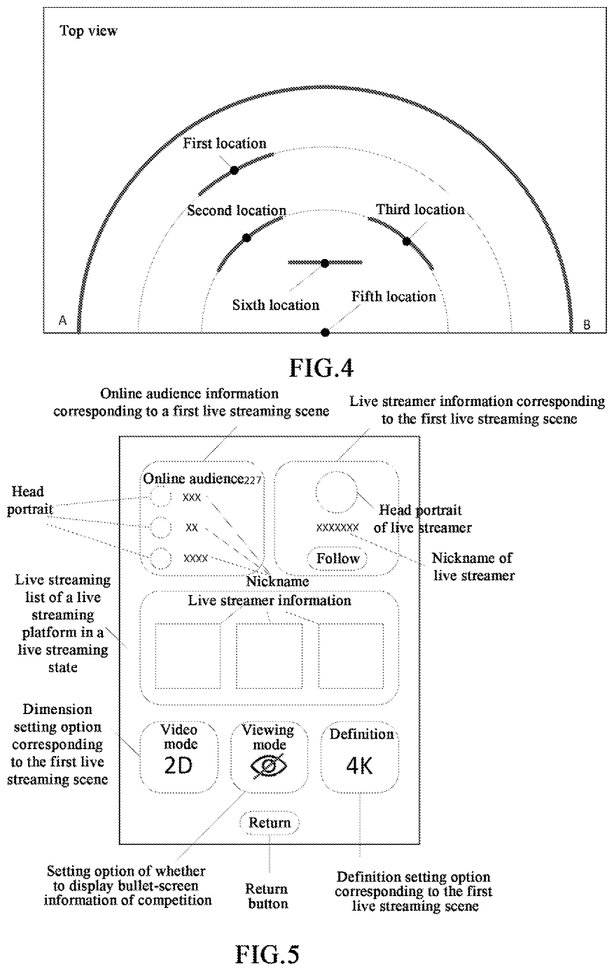

In some embodiments, the second display screen may be a curved-surface screen or a planar screen, and when the second display screen is a curved-surface screen, referring to FIG. 4, FIG. 4 is a schematic top view of the playing field space provided in an embodiment of the present application.

In some embodiments, the second location may be preset, and the second location may be a three-dimensional coordinate.

In some embodiments, the distance between the second location and the virtual object corresponding to the user is the distance between the second location and the fifth location.

Referring to FIG. 5, FIG. 5 is a schematic diagram of the second display screen provided in an embodiment of the present application, the online audience information corresponding to the first live streaming scene may include the number of online audiences (227) currently viewing the first live streaming scene, and head portrait information and nickname information of some online audiences; the live streamer information corresponding to the first live streaming scene may include head portrait information and nickname information of a live streamer of the first live streaming scene, and if the current user has not followed the live streamer of the first live streaming scene, a “follow” button may also be displayed in an area below the head portrait information and the nickname information of the live streamer of the first live streaming scene; the live streaming list of the live streaming platform in the live streaming state may include live streamer information of a live streaming scene in the live streaming state in the current live streaming platform, wherein the live streamer information includes the head portrait information and the nickname information of the live streamer; the dimension setting option of the playing field space is used by the user to set a video mode, the video mode may be a 2D mode or a 3D mode, and the user may switch the video mode by clicking on a button of the dimension setting option; the setting option of whether to display bullet-screen messages of the competition is used by the user to set a viewing mode, and the viewing mode may be a mode of displaying the bullet-screen messages in the first live streaming scene or a mode of not displaying the bullet-screen messages in the first live streaming scene; and the definition setting option corresponding to the first live streaming scene is used by the user to set the definition for displaying the current first live streaming scene.

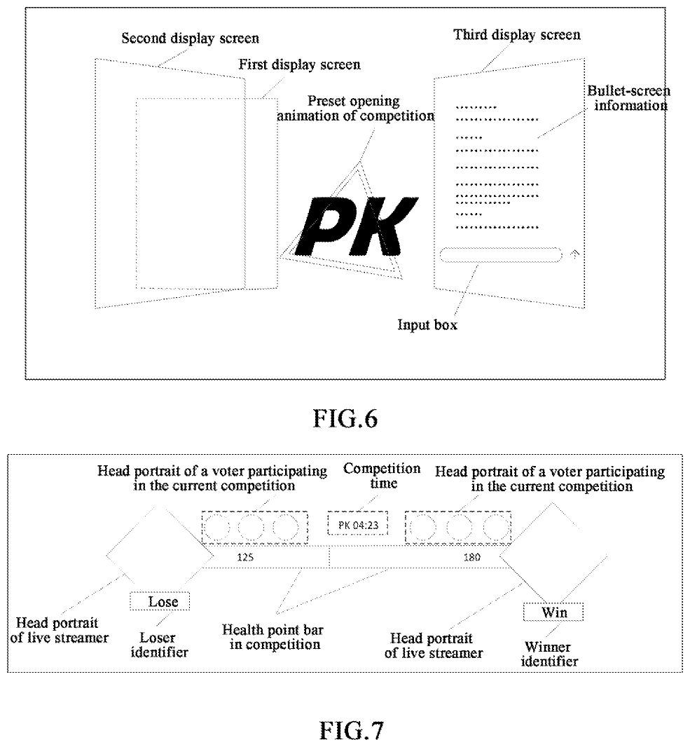

In some embodiments, for display content of the playing field space when the user enters the first live streaming scene, the method further comprises: in response to detecting that the user enters the first live streaming scene, triggering the execution of: displaying the first live streaming scene in the set playing field space; in response to the preset operation, presenting the first display screen at the first location in the playing field space and displaying the second live streaming scene in the first display screen; displaying the second display screen at the second location in the playing field space; and displaying a preset opening animation of the competition at a sixth location of the playing field space. Referring to FIG. 4, the sixth location may be located between the fifth location and the first live streaming scene. Referring to FIG. 6, FIG. 6 is a front view of the playing field space provided in an embodiment of the present application, the preset opening animation of the competition may include a “PK” word, and the preset opening animation of the competition may be displayed in a lower area of the playing field space. In the playing field space, the distance between the second location and the virtual object is less than the distance between the first location and the virtual object, so that the second display screen located at the second location can be completely displayed, and some area of the first display screen located at the first location may be shielded by the second display screen, so that the stereoscopic impression of the three-dimensional playing field space can be enhanced, thereby enhancing the immersive feeling of the user, and improving the user experience.

In some embodiments, the fifth location, the sixth location and the center of the first live streaming scene are on the same plane.

In some embodiments, in a case that the first display screen is displayed at the first location in the playing field space, and the second display screen is displayed at the second location in the playing field space, the user cannot trigger the first display screen.

In some embodiments, in a case that the first display screen is displayed at the first location in the playing field space, and the second display screen is displayed at the second location in the playing field space, the transparency of the first display screen may be 50%.

In some embodiments, for the adjustment on the location where the first display screen and/or the second display screen is located, the method further comprises:
in response to detecting that the second display screen is turned off, controlling the first display screen to move to the second location.

In some embodiments, in response to detecting that the user does not interact with the second display screen exceeding a preset duration, the second display screen is turned off; and
in some other embodiments, in a case that a trigger operation for a return button in the second display screen is detected, the second display screen is turned off, with reference to FIG. 5, the return button with a “return” word is further displayed in the second display screen, and the user may trigger the return button through a handheld apparatus such as a handle or an action capture glove.

In response to detecting that the second display screen is turned off, the first display screen is controlled to move to the second location that is closer to a virtual user, so that the user can view the first display screen more clearly. Thus the user experience is improved.

In some embodiments, for the adjustment on the location where the first display screen and/or the second display screen is located, the method further comprises:
in response to a hovering or dragging operation of the user on the first display screen, controlling the first display screen to move to the second location, and controlling the second display screen to move to the first location.

In some embodiments, the user may perform the hovering or dragging operation on the display screen of the competition through a handheld apparatus such as a handle or an action capture glove, in response to detecting the hovering or dragging operation on the first display screen performed by the user, a virtual hand corresponding to the virtual object may be displayed in the playing field space, and the virtual hand may further hold a virtual handheld apparatus (e.g., a virtual pen), so that the user can flexibly adjust the locations of the first display screen and the second display screen in the playing field space by using the handheld apparatus. Thus the user experience is improved.

In some embodiments, the method further comprises:
displaying a third display screen at a third location in the playing field space (as shown in FIG. 4), wherein the third display screen is used for displaying bullet-screen messages sent by the user in the first live streaming scene in the competition state;
wherein the first location and the third location are symmetrically distributed on two sides of a symmetry axis of the first live streaming scene;
or, the second location and the third location are symmetrically distributed on the two sides of the symmetry axis of the first live streaming scene.

Referring to FIG. 4, the third display screen is further used for displaying an input box, and the user may input and send the bullet-screen messages in the input box through the handheld apparatus, and give a virtual gift or like to a live streamer.

In some embodiments, the method further comprises:
in response to detecting that the first live streaming scene is in a competition state, displaying a fourth display screen above the first display screen, wherein the fourth display screen is used for displaying information of a situation of the competition.

In some embodiments, in response to detecting a player killing (PK) in the first live streaming scene with another live streaming scene (the second live streaming scene), it is determined that the first live streaming scene is in the competition state. The live streamer of the first live streaming scene may initiate the PK to the other live streaming scene (the second live streaming scene) in an invitation or random matching manner.

FIG. 7 is a schematic diagram of the fourth display screen provided in an embodiment of the present application, the information of a situation of the competition may include head portrait information of live streamers in the live streaming scenes of both competition parties, and competition time information, wherein the competition time information may be a time for which a competition has been performed, or a remaining time of the competition.

In some embodiments, the information of a situation of the competition may further include: identification information of a winner, identification information of a loser, health points bar in the competition corresponding to the live streaming scenes of the both parties, and head portrait information of some of the voters participating in the current competition, etc.

In some embodiments, the information of a situation of the competition may further include the numbers of votes (125 and 180 as shown in FIG. 7) respectively corresponding to the live streamers of the both parties.

In some embodiments, the method further comprises:
in response to a hovering or dragging operation of the user for the fourth display screen, controlling the fourth display screen to move to the second location, and controlling the second display screen to move to the first location or a fourth location, wherein the fourth location is located above or below the first location.

In some embodiments, the user may perform the hovering or dragging operation on the fourth display screen of the competition through a handheld apparatus such as a handle or an action capture glove, so as to flexibly adjust the locations of the second display screen and the fourth display screen in the scene picture, thereby improving the user experience.

In some embodiments, the method further comprises:
in a case that the first display screen is located at the second location and the fourth display screen is located above the first display screen, in response to a click operation on the fourth display screen, displaying ranking information of the current competition on the fourth display screen, and controlling the first display screen to move to the first location.

In some embodiments, the step of displaying, in response to the click operation on the fourth display screen, the ranking information of the current competition on the fourth display screen comprises:
in response to the click operation on a display area, where at least one of the following items corresponding to a target live streaming scene in the fourth display screen is located, displaying, on the fourth display screen, the ranking information of the target live streaming scene in the current competition: a health points bar in the competition, head portrait information of the live streamer, and head portrait information of some of the voters, wherein the target live streaming scene is any live streaming scene in the live streaming scenes of both competition parties.

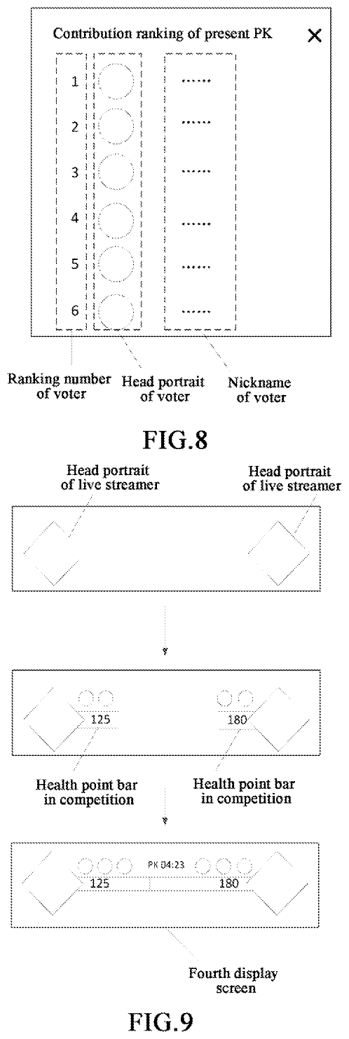

In some embodiments, referring to FIG. 8, FIG. 8 is a schematic diagram of the ranking information provided in an embodiment of the present application, the ranking information includes title information of “contribution ranking of the present PK”, head portrait information and nickname information of some of the voters corresponding to the target live streaming scene, and ranking numbers of some of the voters.

In some embodiments, the method further comprises:
in a case that the ranking information of the current competition is displayed on the fourth display screen, in response to triggering a turn-off instruction for the ranking information of the current competition, turning off the ranking information of the current competition.

Specifically, the user may trigger the turn-off instruction for the ranking information of the current competition by triggering a shortcut key on the handheld apparatus, and/or, clicking a preset area in the scene picture.

In some embodiments, the method further comprises:
acquiring first pose information of a head-mounted display device;
determining a target scene picture in the current first live streaming scene based on the first pose information; and
displaying, in the playing field space, the target scene picture in the first live streaming scene.

In some embodiments, the first pose information includes first location information and first posture information, wherein the first location information is coordinate information of the head-mounted display device in a world coordinate system (i.e., a real world), and the first posture information is posture information of the head-mounted display device in the world coordinate system (i.e., the real world).

Optionally, the coordinate information of the head-mounted display device in the world coordinate system (i.e., the real world) may be determined according to a positioning function of the head-mounted display device, and specifically with regard to the determination of the coordinate information of the head-mounted display device in the world coordinate system (i.e., the real world), reference may be made to related arts, for example, the GPS technology, and thus will not be repeated here again.

In some embodiments, the determining the target scene picture in the current first live streaming scene based on the first pose information comprises:
acquiring a first preset correspondence, wherein the first preset correspondence includes an association relationship between pose information in the world coordinate system and pose information in a camera coordinate system;
determining second pose information of the virtual object according to the first pose information and the first preset correspondence;
acquiring a second preset correspondence, wherein the second preset correspondence includes a plurality of pieces of pose information and an alternative picture corresponding to each of the plurality of pieces of pose information;
determining an alternative picture corresponding to the second pose information based on the second pose information and the second preset correspondence; and
determining the alternative picture corresponding to the second pose information to be the target scene picture in the current first live streaming scene.

In some embodiments, the location relationship between the first location and the virtual object corresponding to the user is fixed.

In some embodiments, the location relationship between the first location and an initial center of the first live streaming scene is fixed.

In some embodiments, the initial center of the first live streaming scene is a center point of the first live streaming scene at a moment when the user enters the first live streaming scene.

In some embodiments, the step of displaying the fourth display screen above the first display screen comprises:
displaying the fourth display screen above the first display screen according to a first preset display mode, wherein the first preset display mode includes any one of the following: a splitting effect, a wipe effect, a fly-in effect and a fade-out effect.

In some embodiments, in a case that the first preset display mode is the splitting effect, referring to FIG. 9, FIG. 9 is a schematic diagram of a display process of displaying the fourth display screen above the first display screen according to the first preset display mode, in a case that the first preset display mode is the splitting effect, the head portrait information of the live streamers of the live streaming scenes of the both competition parties is displayed at first, and then competition health points bar of the live streaming scenes of the both parties are gradually unfolded from the two sides for display, until the fourth display screen is completely displayed, wherein “∘” in FIG. 9 refers to the head portrait of a corresponding voting user.

In some embodiments, displaying the first display screen at the first location in the playing field space comprises: displaying the first display screen at the first location in the playing field space according to a second preset display mode, wherein the second preset display mode includes any one of: a splitting effect, a wipe effect, a fly-in effect and a fade-out effect

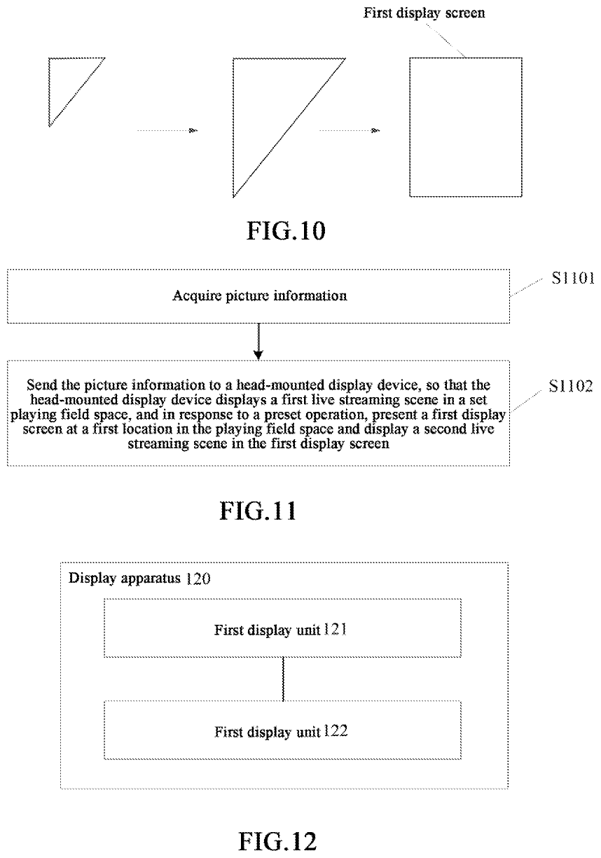

In some embodiments, in a case that the second preset display mode is the wipe effect, referring to FIG. 10, FIG. 10 is a schematic diagram of a process of displaying the first display screen at the first position in the playing field space according to the second preset display mode, in a case that the second preset display mode is the wipe effect, wherein the first display screen may be gradually unfolded from the upper left corner to the lower right corner for display, until the first display screen is completely displayed.

In some embodiments, in response to a turn-off operation of the user for the first display screen and/or the fourth display screen, the first display screen and/or the fourth display screen is turned off in the playing field space according to a third preset display mode. The third preset display mode may be a fade-out effect, that is, the transparency of the first display screen and/or the fourth display screen is controlled to gradually change from 100% to 0%, and when the transparency of the first display screen and/or the fourth display screen is 0%, the first display screen and/or the fourth display screen is turned off.

FIG. 11 is a schematic flowchart of a data processing method provided in an exemplary embodiment of the present application, the method may be applied to the second device 20, and the method at least includes the following steps S1101 to S1102:
S1101, acquiring picture information, wherein the picture information comprises: a first live streaming scene corresponding to a first device, a first location, first information used for instructing a head-mounted display device to display a first display screen, and a second live streaming scene to be displayed in the first display screen; and
S1102, sending the picture information to the head-mounted display device to case the head-mounted display device to display the first live streaming scene in a set playing field space, and in response to a preset operation, presenting the first display screen at the first position in the playing field space and displaying the second live streaming scene in the first display screen.

FIG. 12 is a schematic structural diagram of a display apparatus provided in an exemplary embodiment of the present application, wherein the apparatus 120 comprises:
a first display unit 121, configured to display a first live streaming scene in a set playing field space; and
a second display unit 122, configured to in response to a preset operation, present a first display screen at a first location in the playing field space and display a second live streaming scene in the first display screen.

In some optional embodiments, the set playing field space is a 180° spherical space or a 360° spherical space.

In some optional embodiments, the first live streaming scene is a 180° 3D video stream picture, and the second live streaming scene is a 2D video stream picture.

In some optional embodiments, the apparatus 120 is further configured to: display a second display screen at a second location in the playing field space, wherein the second display screen is used for displaying at least one of the following: a live streaming list of a live streaming platform in a live streaming state, live streamer information corresponding to the first live streaming scene, online audience information corresponding to the first live streaming scene, a definition setting option corresponding to the first live streaming scene, a dimension setting option corresponding to the first live streaming scene, and a setting option of whether to display bullet-screen messages of the competition.

In some optional embodiments, the apparatus 120 is further configured to: in response to a hovering or dragging operation of the user for the first display screen, control the first display screen to move to the second location, and control the second display screen to move to the first location.

In some optional embodiments, the apparatus 120 is further configured to: in response to detecting that the second display screen is turned off, control the first display screen to move to the second location.

In some optional embodiments, the apparatus 120 is further configured to: display a third display screen at a third location in the playing field space, wherein the third display screen is used for displaying bullet-screen messages sent by the user in the first live streaming scene; and
the first location and the third location are symmetrically distributed on two sides of a symmetry axis of the first live streaming scene, or the second location and the third location are symmetrically distributed on the two sides of the symmetry axis of the first live streaming scene.

In some optional embodiments, the apparatus 120 is further configured to: in response to detecting that the first live streaming scene is in a competition state, display a fourth display screen above the first display screen, wherein the fourth display screen is used for displaying information of a situation of the competition.

In some optional embodiments, the apparatus 120 is further configured to: in response to a hovering or dragging operation of the user for the fourth display screen, control the fourth display screen to move to the second location, and control the second display screen to move to the first location or a fourth location, wherein the fourth location is located above or below the first location.

In some optional embodiments, the apparatus 120 is further configured to: in a case that the first display screen is located at the second location and the fourth display screen is located above the first display screen, in response to a click operation on the fourth display screen, display ranking information of the current competition on the fourth display screen, and control the first display screen to move to the first location.

In some optional embodiments, when being used for displaying the first live streaming scene in the set playing field space, the apparatus 120 is specifically configured to:
acquire first pose information of a head-mounted display device;
determine a target scene picture in the current first live streaming scene based on the first pose information; and
display, in the playing field space, the target scene picture in the first live streaming scene.

In some optional embodiments, the location relationship between the first location and a virtual object corresponding to the user is fixed.

In some optional embodiments, the location relationship between the first location and an initial center of the first live streaming scene is fixed.

In some optional embodiments, when being configured to display the fourth display screen above the first display screen, the first display unit 121 is specifically configured to:
display the fourth display screen above the first display screen according to a first preset display mode, wherein the first preset display mode includes any one of: a splitting effect, a wipe effect, a fly-in effect and a fade-out effect.

In some optional embodiments, when being configured to present the first display screen at the first location in the playing field space, the second display unit 122 is specifically configured to:
present the first display screen at the first location in the playing field space according to a second preset display mode, wherein the second preset display mode includes any one of: a splitting effect, a wipe effect, a fly-in effect and a fade-out effect.

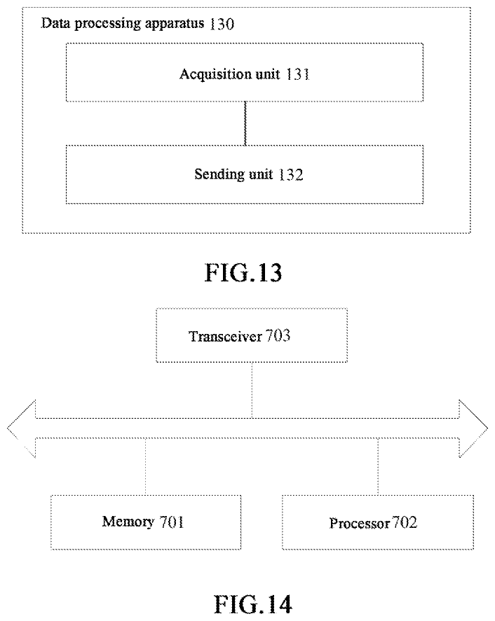

FIG. 13 is a schematic structural diagram of a data processing apparatus 130 provided in an exemplary embodiment of the present application, wherein the apparatus 130 comprises:
an acquisition unit 131, configured to acquire picture information, wherein the picture information comprises: a first live streaming scene corresponding to a first device, a first location, first information used for instructing a head-mounted display device to display a first display screen, and a second live streaming scene to be displayed in the first display screen; and
a sending unit 132, configured to send the picture information to the head-mounted display device cause the head-mounted display device to display the first live streaming scene in a set playing field space, in response to a preset operation, present the first display screen at the first location in the playing field space and display the second live streaming scene in the first display screen.

It should be understood that the apparatus embodiments and the method embodiments may correspond to each other, and similar description may refer to the method embodiments. In order to avoid repetition, details are not described herein again. Specifically, the apparatus may execute the above method embodiments, and the foregoing and other operations and/or functions of the modules in the apparatus are respectively corresponding processes in the methods in the above method embodiments, and are not described herein again for brevity.

The apparatus in the embodiments of the present application is described above in the perspective of a functional module in conjunction with the drawings. It should be understood that the functional module may be implemented in a hardware form, or may be implemented by instructions in a software form, or may be implemented by a combination of hardware and software modules. Specifically, the steps of the method embodiments in the embodiments of the present application may be completed by an integrated logic circuit of hardware in a processor and/or instructions in the software form, and the steps of the method disclosed in combination with the embodiments of the present application may be directly executed by a hardware decoding processor, or executed by a combination of hardware and software modules in the decoding processor. Optionally, the software module may be located in a mature storage medium in the art, such as a random access memory, a flash memory, a read-only memory, a programmable read-only memory, an electrically erasable programmable memory and a register. The storage medium is located in a memory, and the processor reads information in the memory and completes the steps in the above method embodiments in combination with the hardware of the memory.

FIG. 14 is a schematic block diagram of an electronic device provided in an embodiment of the present application, wherein the electronic device may include:
a memory 701 and a processor 702, wherein the memory 701 is used for storing a computer program, and transmitting the program code to the processor 702. In other words, the processor 702 may invoke and run the computer program from the memory 701, so as to implement the method in the embodiments of the present application.

For example, the processor 702 may be used for executing the above method embodiments according to instructions in the computer program.

In some embodiments of the present application, the processor 702 may include, but is not limited to:
a general-purpose processor, a digital signal processor (DSP), an application specific integrated circuit (ASIC), a field programmable gate array (FPGA), or other programmable logic devices, a discrete gate or a transistor logic device, a discrete hardware component, etc.

In some embodiments of the present application, the memory 701 includes, but is not limited to:
a volatile memory and/or a non-volatile memory, wherein the non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), which is used as an external cache. By way of example but not restrictive illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synch link dynamic random access memory (synch link DRAM, SLDRAM), and Direct Rambus random access memory (Direct Rambus RAM, DR RAM).

In some embodiments of the present application, the computer program may be divided into one or more modules, and the one or more modules are stored in the memory 701 and are executed by the processor 702, so as to complete the method provided in the present application. The one or more modules may be a series of computer program instruction segments capable of completing a specific function, and the instruction segments are used for describing an execution process of the computer program in the electronic device.

As shown in FIG. 14, the electronic device may further include:
a transceiver 703, which may be connected to the processor 702 or the memory 701.

The processor 702 may control the transceiver 703 to communicate with other devices, and specifically, may send information or data to the other devices, or receive information or data sent by the other devices. The transceiver 703 may include a transmitter and a receiver. The transceiver 703 may further include an antenna, and there may be one or more antennas.

It should be understood that the components in the electronic device are connected by means of a bus system, wherein the bus system further includes a power bus, a control bus and a state signal bus in addition to a data bus.

The present application further provides a non-transitory computer storage medium, on which a computer program is stored, wherein the computer program, when executed by a computer, enables the computer to execute the method in the above method embodiments. Or, an embodiment of the present application further provides a computer program product including an instruction, wherein the instruction, when executed by a computer, causes the computer to execute the method in the above method embodiments.

When implemented using software, all or in part may be implemented in the form of the computer program product. The computer program product includes one or more computer instructions. When the computer program instructions are loaded and executed on a computer, the processes or functions according to the embodiments of the present application are all or partially generated. The computer may be a general-purpose computer, a special-purpose computer, a computer network, or other programmable apparatuses. The computer instructions may be stored in a computer-readable storage medium or transmitted from one computer-readable storage medium to another computer-readable storage medium, for example, the computer instructions may be transmitted from one website site, one computer, one server or one data center to another website site, another computer, another server, or another data center in a wired manner (e.g., a coaxial cable, an optical fiber, a digital subscriber line (DSL)), or a wireless manner (e.g., infrared, wireless, microwave, and the like). The computer-readable storage medium may be any available medium accessible by the computer, or a data storage device such as a server or a data center, which is integrated with one or more usable media. The available medium may be a magnetic medium (e.g., a floppy disk, a hard disk, or a magnetic tape), an optical medium (e.g., a digital video disc (DVD)), or a semiconductor medium (e.g., a solid state disk (SSD)), etc.

According to one or more embodiments of the present application, provided is a display method, comprising:
displaying a first live streaming scene in a set playing field space; and
in response to a preset operation, presenting a first display screen at a first location in the playing field space and displaying a second live streaming scene in the first display screen.

According to one or more embodiments of the present application, the set playing field space is a 180° spherical space or a 360° spherical space.

According to one or more embodiments of the present application, the first live streaming scene is a 180° 3D video stream picture, and the second live streaming scene is a 2D video stream picture.

According to one or more embodiments of the present application, the method further comprises:
displaying a second display screen at a second location in the playing field space, wherein the second display screen is used for displaying at least one of: a live streaming list of a live streaming platform in a live streaming state, live streamer information corresponding to the first live streaming scene, online audience information corresponding to the first live streaming scene, a definition setting option corresponding to the first live streaming scene, a dimension setting option corresponding to the first live streaming scene, and a setting option of whether to display bullet-screen messages of a competition.

According to one or more embodiments of the present application, the method further comprises:
in response to a hovering or dragging operation of a user on the first display screen, controlling the first display screen to move to the second location, and controlling the second display screen to move to the first location.

According to one or more embodiments of the present application, the method further comprises:
in response to detecting that the second display screen is turned off, controlling the first display screen to move to the second location.

According to one or more embodiments of the present application, the method further comprises:
displaying a third display screen at a third location in the playing field space, the third display screen being used for displaying bullet-screen messages sent by the user in the first live streaming scene; and
wherein the first location and the third location are symmetrically distributed on two sides of a symmetry axis of the first live streaming scene, or the second location and the third location are symmetrically distributed on the two sides of the symmetry axis of the first live streaming scene.

According to one or more embodiments of the present application, the method further comprises:
in response to detecting that the first live streaming scene is in a competition state, displaying a fourth display screen above the first display screen, wherein the fourth display screen is used for displaying information of a situation of the competition.

According to one or more embodiments of the present application, the method further comprises:
in response to a hovering or dragging operation of the user for the fourth display screen, controlling the fourth display screen to move to the second location, and controlling the second display screen to move to the first location or a fourth location, wherein the fourth location is located above or below the first location.

According to one or more embodiments of the present application, the method further comprises:
in a case that the first display screen is located at the second location and the fourth display screen is located above the first display screen, in response to a click operation on the fourth display screen, displaying ranking information of the current competition on the fourth display screen, and controlling the first display screen to move to the first location.

According to one or more embodiments of the present application, the step of displaying the first live streaming scene in the set playing field space comprises:
acquiring first pose information of a head-mounted display device;
determining a target scene picture in the current first live streaming scene based on the first pose information; and
displaying, in the playing field space, the target scene picture in the first live streaming scene.

According to one or more embodiments of the present application, the location relationship between the first location and a virtual object corresponding to the user is fixed.

According to one or more embodiments of the present application, the location relationship between the first location and an initial center of the first live streaming scene is fixed.

According to one or more embodiments of the present application, the step of displaying the fourth display screen above the first display screen comprises:
displaying the fourth display screen above the first display screen according to a first preset display mode, wherein the first preset display mode comprises any one of: a splitting effect, a wipe effect, a fly-in effect and a fade-out effect.

According to one or more embodiments of the present application, the step of presenting the first display screen at the first location in the playing field space comprises:
presenting the first display screen at the first location in the playing field space according to a second preset display mode, wherein the second preset display mode comprises any one of: a splitting effect, a wipe effect, a fly-in effect and a fade-out effect.

According to one or more embodiments of the present application, provided is a data processing method, including:
acquiring picture information, wherein the picture information comprises: a first live streaming scene corresponding to a first device, a first location, first information used for instructing a head-mounted display device to display a first display screen, and a second live streaming scene to be displayed in the first display screen; and
sending the picture information to the head-mounted display device to cause the head-mounted display device to display the first live streaming scene in a set playing field space, and in response to a preset operation, presenting the first display screen at the first location in the playing field space and displaying the second live streaming scene in the first display screen.

According to one or more embodiments of the present application, provided is a display apparatus, including:
a first display unit, configured to display a first live streaming scene in a set playing field space; and
a second display unit, configured to in response to a preset operation, present a first display screen at a first location in the playing field space and display a second live streaming scene in the first display screen.

According to one or more embodiments of the present application, the set playing field space is a 180° spherical space or a 360° spherical space.

According to one or more embodiments of the present application, the first live streaming scene is a 180° 3D video stream picture, and the second live streaming scene is a 2D video stream picture.

According to one or more embodiments of the present application, the apparatus is further configured to:
display a second display screen at a second location in the playing field space, wherein the second display screen is used for displaying at least one of the following: a live streaming list of a live streaming platform in a live streaming state, live streamer information corresponding to the first live streaming scene, online audience information corresponding to the first live streaming scene, a definition setting option corresponding to the first live streaming scene, a dimension setting option corresponding to the first live streaming scene, and a setting option of whether to display bullet-screen messages of the competition.

According to one or more embodiments of the present application, the apparatus is further configured to:
in response to a hovering or dragging operation of a user on the first display screen, control the first display screen to move to the second location, and controlling the second display screen to move to the first location.

According to one or more embodiments of the present application, the apparatus is further configured to:
in response to detecting that the second display screen is turned off, control the first display screen to move to the second location.

According to one or more embodiments of the present application, the apparatus is further configured to:
display a third display screen at a third location in the playing field space, the third display screen being used for displaying bullet-screen messages sent by the user in the first live streaming scene; and
wherein the first location and the third location are symmetrically distributed on two sides of a symmetry axis of the first live streaming scene, or the second location and the third location are symmetrically distributed on the two sides of the symmetry axis of the first live streaming scene.

According to one or more embodiments of the present application, the apparatus is further configured to:
in response to detecting that the first live streaming scene is in a competition state, display a fourth display screen above the first display screen, wherein the fourth display screen is used for displaying information of a situation of the competition.

According to one or more embodiments of the present application, the apparatus is further configured to:
in response to a hovering or dragging operation of the user for the fourth display screen, control the fourth display screen to move to the second location, and control the second display screen to move to the first location or a fourth location, wherein the fourth location is located above or below the first location.

According to one or more embodiments of the present application, the apparatus is further configured to:
in a case that the first display screen is located at the second location and the fourth display screen is located above the first display screen, in response to a click operation on the fourth display screen, display ranking information of the current competition on the fourth display screen, and control the first display screen to move to the first location.

According to one or more embodiments of the present application, when being used for displaying the first live streaming scene in the set playing field space, the apparatus is specifically configured to:
acquire first pose information of a head-mounted display device;
determine a target scene picture in the current first live streaming scene on the basis of the first pose information; and
display, in the playing field space, the target scene picture in the first live streaming scene.

According to one or more embodiments of the present application, the location relationship between the first location and a virtual object corresponding to the user is fixed.

According to one or more embodiments of the present application, the location relationship between the first location and an initial center of the first live streaming scene is fixed.

According to one or more embodiments of the present application, when being used for displaying the fourth display screen above the first display screen, the apparatus is specifically configured to:
display the fourth display screen above the first display screen according to a first preset display mode, wherein the first preset display mode comprises any one of: a splitting effect, a wipe effect, a fly-in effect and a fade-out effect.

According to one or more embodiments of the present application, when being configured to present the first display screen at the first location in the playing field space, the apparatus is specifically configured to:
present the first display screen at the first location in the playing field space according to a second preset display mode, wherein the second preset display mode comprises any one of: a splitting effect, a wipe effect, a fly-in effect and a fade-out effect.

According to one or more embodiments of the present application, provided is a data processing apparatus, including:
an acquisition unit, configured to acquire picture information, wherein the picture information comprises: a first live streaming scene corresponding to a first device, a first location, first information used for instructing a head-mounted display device to display a first display screen, and a second live streaming scene to be displayed in the first display screen; and
a sending unit, configured to sending the picture information to the head-mounted display device to cause the head-mounted display device to display the first live streaming scene in a set playing field space, and in response to a preset operation, presenting the first display screen at the first location in the playing field space and displaying the second live streaming scene in the first display screen.

According to one or more embodiments of the present application, provided is an electronic device, including:
a processor; and
a memory, used for storing an executable instruction of the processor,
wherein the processor is configured to execute the methods by executing the executable instruction.

According to one or more embodiments of the present application, provided is a computer-readable storage medium, on which a computer program is stored, wherein the computer program, when executed by a processor, implements the above methods.

According to one or more embodiments of the present application, provided is a computer program, which, when executed by a processor, implements the above methods.

Those ordinary skilled in the art may be aware that, modules and algorithm steps of the examples described in combination with the embodiments disclosed herein may be implemented by electronic hardware, or a combination of computer software and electronic hardware. Whether these functions are executed by hardware or software depends on specific applications and design constraint conditions of the technical solutions. Those skilled in the art may use different methods to implement the described functions for each specific application, but it should not be considered that the implementation goes beyond the scope of the present application.

In several embodiments provided in the present application, it should be understood that the disclosed system, apparatus and method may be implemented in other manners. For example, the apparatus embodiments described above are merely exemplary, for example, the division of the modules is only a logic function division, there may be other division manners in practical implementation, for example, a plurality of modules or components may be combined or integrated to another system, or some features may be omitted or not executed. From another point of view, the displayed or discussed mutual coupling or direct coupling or communication connection may be indirect coupling or communication connection of apparatuses or modules through some interfaces, and may be in electrical, mechanical or other forms.

The modules described as separate components may be separated physically or not, components displayed as modules may be physical modules or not, namely, may be located in one place, or may be distributed on a plurality of network units. Some or all of the modules may be selected to implement the purposes of the solutions in the present embodiment according to actual demands. For example, the functional modules in various embodiments of the present application may be integrated in one processing module, or the modules individually exist physically, or two or more modules are integrated in one module.

The foregoing descriptions are merely specific embodiments of the present application, but the protection scope of the present application is not limited thereto. Any skilled one who is familiar with this art could readily think of variations or substitutions within the disclosed technical scope of the present application, and these variations or substitutions shall fall within the protection scope of the present invention. Accordingly, the protection scope of the present application shall be subject to the protection scope of the claims.

I/We claim:

1. A display method, comprising:
displaying a first live streaming scene in a set playing field space; and
in response to a preset operation, presenting a first display screen at a first location in the playing field space and displaying a second live streaming scene in the first display screen.

2. The method according to claim 1, wherein the playing field space is a 180° spherical space or a 360° spherical space.

3. The method according to claim 1, wherein the first live streaming scene is a 180° 3D video stream picture, and the second live streaming scene is a 2D video stream picture.

4. The method according to claim 1, the method further comprising:
displaying a second display screen at a second location in the playing field space, wherein the second display screen is used for displaying at least one of: a live streaming list of a live streaming platform in a live streaming state, live streamer information corresponding to the first live streaming scene, online audience information corresponding to the first live streaming scene, a definition setting option corresponding to the first live streaming scene, a dimension setting option corresponding to the first live streaming scene, and a setting option of whether to display bullet-screen messages of a competition.

5. The method according to claim 4, the method further comprising:
in response to a hovering or dragging operation of a user on the first display screen, controlling the first display screen to move to the second location, and controlling the second display screen to move to the first location.

6. The method according to claim 4, the method further comprising:
in response to detecting that the second display screen is turned off, controlling the first display screen to move to the second location.

7. The method according to claim 4, the method further comprising:
displaying a third display screen at a third location in the playing field space, the third display screen being used for displaying bullet-screen messages sent by a user in the first live streaming scene; and
wherein the first location and the third location are symmetrically distributed on two sides of a symmetry axis of the first live streaming scene, or the second location and the third location are symmetrically distributed on the two sides of the symmetry axis of the first live streaming scene.

8. The method according to claim 6, the method further comprising:
in response to detecting that the first live streaming scene is in a competition state, displaying a fourth display screen above the first display screen, wherein the fourth display screen is used for displaying information of a situation of the competition.

9. The method according to claim 8, the method further comprising:
in response to a hovering or dragging operation of the user for the fourth display screen, controlling the fourth display screen to move to the second location, and controlling the second display screen to move to the first location or a fourth location, wherein the fourth location is located above or below the first location.

10. The method according to claim 9, the method further comprising:
in a case that the first display screen is located at the second location and the fourth display screen is located above the first display screen, in response to a click operation on the fourth display screen, displaying ranking information of the current competition on the fourth display screen, and controlling the first display screen to move to the first location.

11. The method according to claim 1, wherein displaying the first live streaming scene in the set playing field space comprises:
acquiring first pose information of a head-mounted display device;
determining a target scene picture in the current first live streaming scene based on the first pose information; and
displaying, in the playing field space, the target scene picture in the first live streaming scene.

12. The method according to claim 1, wherein a relationship between the first location and a location of a virtual object corresponding to the user is fixed.

13. The method according to claim 1, wherein a relationship between the first location and a location of an initial center of the first live streaming scene is fixed.

14. The method according to claim 8, wherein displaying the fourth display screen above the first display screen comprises:
displaying the fourth display screen above the first display screen according to a first preset display mode, wherein the first preset display mode comprises any one of: a splitting effect, a wipe effect, a fly-in effect and a fade-out effect.

15. The method according to claim 1, wherein presenting the first display screen at the first location in the playing field space comprises:
presenting the first display screen at the first location in the playing field space according to a second preset display mode, wherein the second preset display mode comprises any one of: a splitting effect, a wipe effect, a fly-in effect and a fade-out effect.

16. A data processing method, comprising:
acquiring picture information, wherein the picture information comprises: a first live streaming scene corresponding to a first device, a first location, first information used for instructing a head-mounted display device to display a first display screen, and a second live streaming scene to be displayed in the first display screen; and
sending the picture information to the head-mounted display device to cause the head-mounted display device to display the first live streaming scene in a set playing field space, and in response to a preset operation, presenting the first display screen at the first location in the playing field space and displaying the second live streaming scene in the first display screen.

17. An electronic device, comprising:
a processor; and
a memory, used for storing executable instructions of the processor,
wherein the processor executing the executable instructions is configured to:
display a first live streaming scene in a set playing field space; and
in response to a preset operation, present a first display screen at a first location in the playing field space and display a second live streaming scene in the first display screen.

18. The device according to claim 17, wherein the playing field space is a 180° spherical space or a 360° spherical space.

19. The device according to claim 17, wherein the first live streaming scene is a 180° 3D video stream picture, and the second live streaming scene is a 2D video stream picture.

20. The device according to claim 17, wherein the processor is further configured to:
display a second display screen at a second location in the playing field space, wherein the second display screen is used for displaying at least one of: a live streaming list of a live streaming platform in a live streaming state, live streamer information corresponding to the first live streaming scene, online audience information corresponding to the first live streaming scene, a definition setting option corresponding to the first live streaming scene, a dimension setting option corresponding to the first live streaming scene, and a setting option of whether to display bullet-screen messages of a competition.
